(19) United States
(12) Patent Application Publication
(10) Pub. No.: US 2024/0379005 A1
(43) Pub. Date: Nov. 14, 2024

(54) TECHNIQUES FOR LARGE-SCALE DETECTION OF LOCATION DATA COLLECTED BY AUTONOMOUS VEHICLES

(71) Applicant: GM Cruise Holdings LLC, San Francisco, CA (US)

(72) Inventor: Marc-Antoine Paré, Seattle, WA (US)

(73) Assignee: GM Cruise Holdings LLC, San Francisco, CA (US)

(21) Appl. No.: 18/316,041

(22) Filed: May 11, 2023

(51) Int. Cl. G08G 1/00; G08G 1/01

(52) U.S. Cl. CPC G08G 1/20; G08G 1/0112; G08G 1/0125

(57) ABSTRACT

A method for detecting AV location data includes receiving a data set from a data store storing data in connection with an autonomous vehicle (AV) fleet, the received data set comprising a plurality of table records; filtering the received data set by comparing data values of the plurality of table records with ranges of latitude values and longitude values and removing table records comprising data values outside both the range of latitude values and the range of longitude values; post-processing the filtered data set to identify tables that include a first table record comprising a data value within the range of latitude values and a corresponding second table record comprising a data value within the range of longitude values; and storing information regarding the identified tables in a data map, wherein the identified tables are tagged to indicate that the identified tables include location information.

### TECHNICAL FIELD OF THE DISCLOSURE

The present disclosure relates generally to autonomous vehicles (AVs) and, more specifically, to techniques for enabling large-scale detection of location data collected by such AVs.

### BACKGROUND

An AV is a vehicle that is capable of sensing and navigating its environment with little or no user input. An autonomous vehicle may sense its environment using sensing devices such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

Figure (FIG. 1 illustrates an example system environment that can be used to facilitate AV dispatch and operations, according to some aspects of the embodiments described herein;

FIG. 2 is a block diagram of a sensor suite, according to some aspects of the embodiments described herein;

FIG. 3 is a block diagram of a fleet management system, according to some aspects of the embodiments described herein;

FIG. 4 is a block diagram of an AV location detector module of the fleet management system, according to some aspects of the embodiments described herein;

FIG. 5 is a block diagram of an onboard computer, according to some aspects of the embodiments described herein;

FIG. 6 is a flowchart of an example method of performing large scale detection of location data collected by AVs performed using the AV location detector module, according to some aspects of the embodiments described herein;

FIGS. 7A-7D show various data tables for illustrating operation of the location detector module, according to some aspects of the embodiments described herein; and

FIG. 8 illustrates an example processor-based system for use in implementing some aspects of embodiments described herein.

### DESCRIPTION OF EXAMPLE EMBODIMENTS OF THE DISCLOSURE

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

AVs collect large amounts of data as they travel, e.g., by using sensors implemented on the AVs. The data can include valuable information for improving performance of AVs, such as information that can be used to train models for controlling AVs. Such models are referred to as “AV control models” or “control models.” However, privacy can be a concern in the usage of the data, as the data often can capture private information, including personal location information, which if disclosed, can result in a loss of privacy, security, or some other benefit. Also, the disclosure or usage of such private information may violate laws, regulations, or company policies. Therefore, it is important to take privacy protection into consideration when data collected by AVs are used to train AV control models and for other purposes.

The sheer volume of sensor data collected by a fleet of AVs makes traditional approaches for detecting and labeling personal data in cloud infrastructure challenging. Location data is of particular privacy relevance for AVs, as it is highly re-identifiable, can lead to significant privacy harm, and is collected in a number of forms by AVs. One thing that makes tracking such data challenging is that AVs collect a lot of data that looks like location data, which comprises a pair of latitude and longitude values, but is not. Off-the-shelf data classification tools either filter such data too aggressively, leading to low recall, or too liberally, leading to low precision as a result of flooding privacy engineers with too many findings.

As described herein, a method for large-scale detection of location data in data collected by AVs (hereinafter “AV location detector”) may be implemented as a cloud-based data processing system on a variety of execution backends. In particular embodiments, a first detection stage, comprising a geofence filter, may be executed in a container-based worker queue. A subsequent post-processing stage may be executed in a local virtual machine (VM) environment. The AV location detector leverages a variety of insights regarding AV data to achieve high scalability and accuracy, including the fact that AV location data may be collected in geo-fenced regions, global positioning system (GPS) location data (i.e., latitude and longitude pairs) can be matched with regular expressions, and AV location data are often split across multiple database columns in a single table.

In accordance with features of embodiments described herein, the AV location detector filters findings to one or more geofence regions and implements a check for a minimum number of digits of precision (location data are not privacy relevant if they are truncated). In certain embodiments, the AV location detector may be implemented as a regular expression (regex), enabling it to be run at scale across a variety of execution backends (e.g., full-text search, BigQuery) and indexed for fast lookups (e.g., with trigram index-based regex searches). A post-processing stage performs a cross-schema check by ensuring that a table contains both a GPS latitude and GPS longitude value, thereby filtering out a large number of false positive findings.

As will be appreciated by one skilled in the art, aspects of the present disclosure described herein may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example AV Management System

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors. Any of the sensor systems implemented as a camera can include light (or luminance) measurement functionality. Sensor systems 104-108 may be collectively referred to as a sensor suite.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Example Sensor Suite

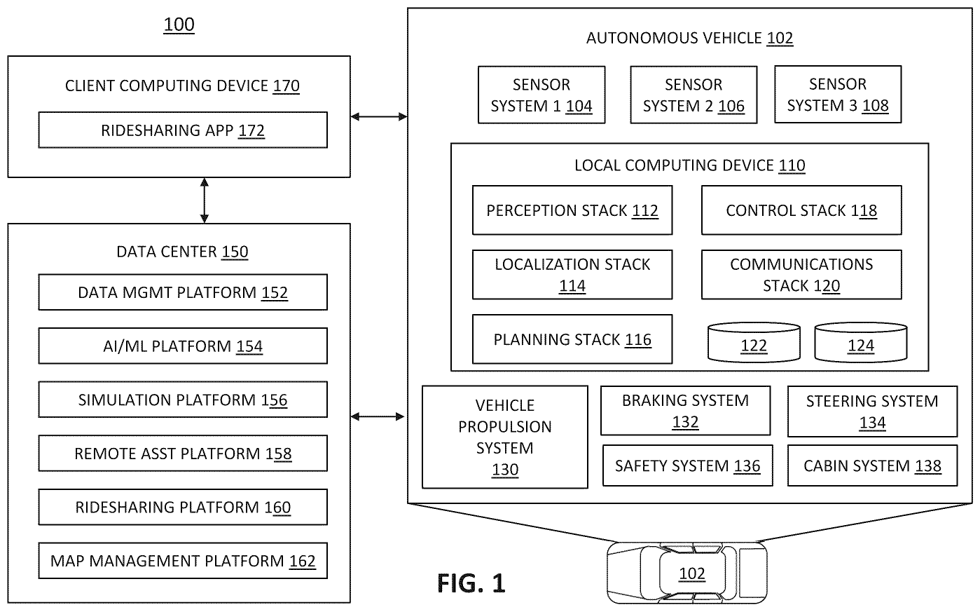

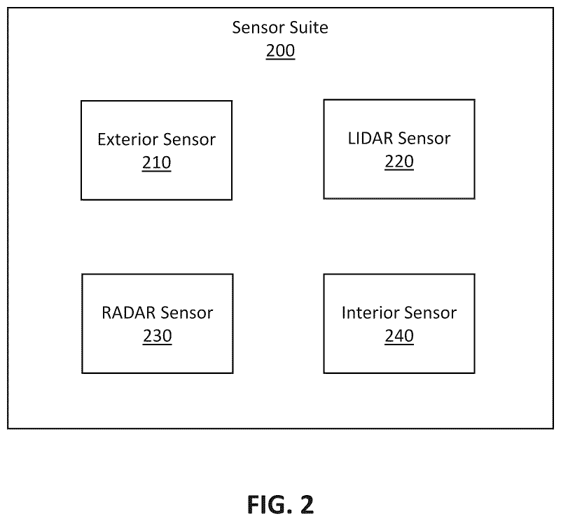

FIG. 2 is a block diagram showing a sensor suite 200 with which an AV, such as AV 102 (FIG. 1), may be equipped according to some embodiments of the present disclosure. As noted above with reference to FIG. 1, sensor systems 104-108 may comprise a sensor suite, such as sensor suite 200. As illustrated in FIG. 2, the sensor suite 200 includes an exterior sensor 210, a LIDAR sensor 220, a RADAR sensor 230, an interior sensor 240, and a user input sensor 250. The sensor suite 200 may include any number of the types of sensors shown in FIG. 2, e.g., one or more exterior sensor 210, one or more LIDAR sensors 220, etc. The sensor suite 200 may have more types of sensors than those shown in FIG. 2, such as the sensors described with reference to FIG. 1. In other embodiments, the sensor suite 200 may not include one or more of the sensors shown in FIG. 2.

The exterior sensor 210 detects objects in an environment around the AV 102. The environment may include a scene in which the AV 102 navigates. Example objects include persons, buildings, traffic lights, traffic signs, vehicles, street signs, trees, plants, animals, or other types of objects that may be present in the environment around the AV 102. In some embodiments, the exterior sensor 210 includes exterior cameras having different views, e.g., a front-facing camera, a back-facing camera, and side-facing cameras. One or more exterior sensor 210 may be implemented using a high-resolution imager with a fixed mounting and field of view. One or more exterior sensors 210 may have adjustable field of views and/or adjustable zooms. In some embodiments, the exterior sensor 210 may operate continually during operation of the AV 102. In an example embodiment, the exterior sensor 210 captures sensor data (e.g., images, etc.) of a scene in which the AV 102 navigates.

The LIDAR sensor 220 measures distances to objects in the vicinity of the AV 102 using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV 102.

The RADAR sensor 230 can measure ranges and speeds of objects in the vicinity of the AV 102 using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

The interior sensor 240 detects the interior of the AV 102, such as objects inside the AV 102. Example objects inside the AV 102 include passengers, components of the AV 102, items delivered by the AV 102, items facilitating services provided by the AV 102, and so on. The interior sensor 240 may include multiple interior cameras to capture different views, e.g., to capture views of an interior feature, or portions of an interior feature. The interior sensor 240 may be implemented with a fixed mounting and fixed field of view, or the interior sensor 240 may have adjustable field of views and/or adjustable zooms, e.g., to focus on one or more interior features of the AV 102. The interior sensor 240 may operate continually during operation of the AV 102. The interior sensor 240 may transmit sensor data to a perception module of the AV 102, which can use the sensor data to classify a feature and/or to determine a status of a feature.

### Example Fleet Management System

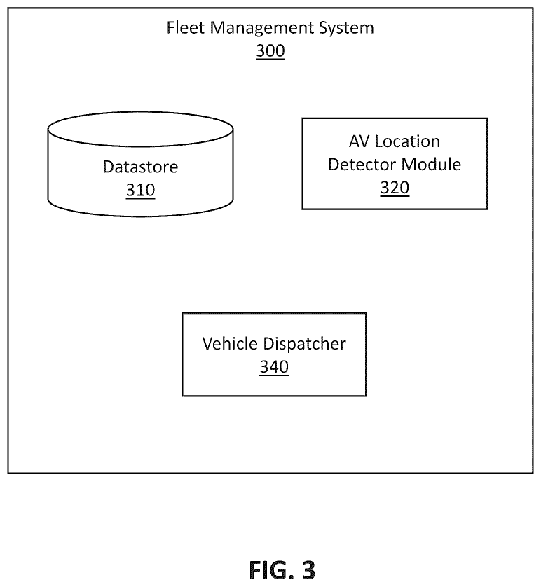

FIG. 3 is a block diagram illustrating a fleet management system 300, which may comprise the data center 150 (FIG. 1), according to some embodiments of the present disclosure. As shown in FIG. 3, the fleet management system 300 includes a datastore 310, an AV location detector module 320, and a vehicle dispatcher 340. In alternative configurations, different and/or additional components may be included in the fleet management system 300. Further, functionality attributed to one component of the fleet management system 300 may be accomplished by a different component included in the fleet management system 300 or a different system than those illustrated. For instance, some or all of the functions of the AV location detector module 320 may be performed by an onboard computer, such as local computing device 110 (FIG. 1).

In particular embodiments, the datastore 310 comprises a data warehouse for storing a variety of data in connection with an operator of an AV fleet for example. The datastore 310 may store data collected by AVs of the AV fleet, which may operate in one or more geofenced areas. In particular embodiments, the datastore 310 may store GPS location data collected by the AVs. In some embodiments, the datastore 310 stores environmental sensor data collected by the AVs. For example, images obtained by exterior cameras of the AVs may be used to learn information about the AVs' environments. The sensor data may be processed to identify particular objects in the environment. In some embodiments, the datastore 310 includes data describing roadways, such as locations of roadways, connections between roadways, roadway names, speed limits, traffic flow regulations, toll information, etc. The datastore 310 may further include data describing buildings (e.g., locations of buildings, building geometry, building types, etc.) that may be present in the environments of an AV 102. The datastore 310 may also include data describing and/or indicating the location of other objects, such as persons, bike lanes, sidewalks, crosswalks, traffic lights, parking lots, signs, billboards, trees, animals, plants, etc.

Other data stored in datastore 310 may include business metrics of the AV fleet operator, user profile data, metadata regarding rides, and third party data sets used for training and testing. In particular embodiments, any type of data may be stored in datastore 310.

In various embodiments, private information may be stored in the datastore 310. Private information is information that if disclosed to others, would result in loss of privacy, security, or some other benefit. Private information may include personal identifiable information (e.g., face, name, address, birth date, phone number, identification (ID) number, social security number, etc.), security information (e.g., account number, account name, passcode, etc.), health information (e.g., medical record, etc.), financial information (e.g., bank account information, etc.), conversation information (e.g., messages, audio, etc.), location and other activity information (e.g., information indicating a location of a person, who the person is with and/or what the person is doing at a given time, etc.), or other types of information that if disclosed, a person, a group of person, or an organization would suffer loss of privacy, security, or some other benefit.

The fleet management system 300 and/or AVs, such as AV 110, may have one or more perception modules to identify objects in the sensor data. Information of these objects may be stored in the datastore 310.

The vehicle dispatcher 340 assigns the AVs in a fleet to various tasks (e.g., service tasks) and directs the movements of the AVs in the fleet. In some embodiments, the vehicle dispatcher 340 includes additional functionalities not specifically shown in FIG. 3. For example, the vehicle dispatcher 340 instructs AV to drive to other locations while not servicing a user, e.g., to improve geographic distribution of the fleet, to anticipate demand at particular locations, etc. The vehicle dispatcher 340 may also instruct AV to return to an AV facility for fueling, inspection, maintenance, or storage. The vehicle dispatcher 340 may perform some or all of the functions of the local computing device 110 that are described above in conjunction with FIG. 1.

In some embodiments, the vehicle dispatcher 340 selects AVs from the fleet to perform various tasks and instructs the AVs to perform the tasks. In some embodiments, the vehicle dispatcher 340 selects an AV based on availability of the AV. For example, the vehicle dispatcher 340 may determine that the AV is available based on a determination that the AV the AV is not performing any task or is going to perform any task that has been assigned to the AV. In cases where a service request specifies a time window, the vehicle dispatcher 340 may determine that the AV is available in the time window. In some embodiments (e.g., embodiments where multiple AVs in the AV fleet are available), the vehicle dispatcher 340 may select one of the available AVs based on other factors, such as physical proximity.

The vehicle dispatcher 340 or another system may maintain or access data describing each of the AVs in the fleet of AVs, including current location, service status (e.g., whether the AV is available or performing a service; when the AV is expected to become available; whether the AV is schedule for future service), fuel or battery level, etc. The vehicle dispatcher 340 may select AVs for service in a manner that optimizes one or more additional factors, including fleet distribution, fleet utilization, and energy consumption. The vehicle dispatcher 340 may interface with one or more predictive algorithms that project future service requests and/or vehicle use, and select vehicles for services based on the projections.

### Example AV Location Detector Module

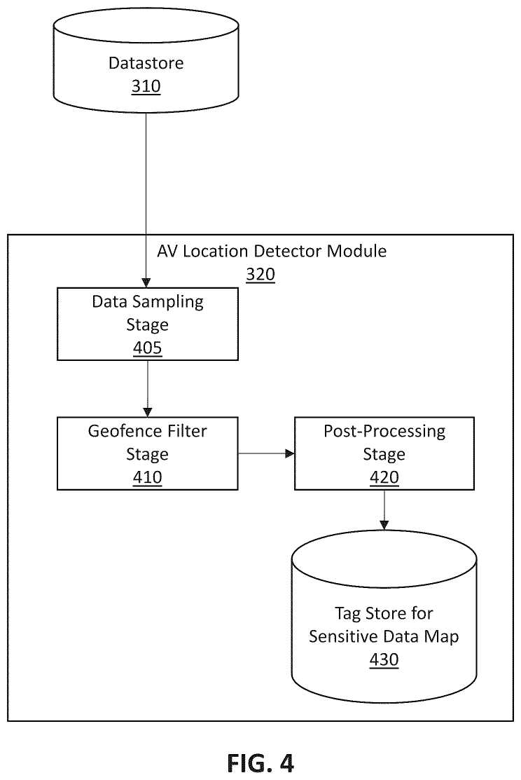

FIG. 4 is a block diagram illustrating the AV location detector module 320 according to some embodiments of the present disclosure. The AV location detector module 320 includes a data sampling stage 405, a geofence filter stage 410, a post-processing stage 420, and a tag store for sensitive data map 430. In alternative configurations, fewer, different and/or additional components may be included in the learning module 320. Also, functionality attributed to one component of the AV location detector module 320 may be accomplished by a different component included in the local computing device 110 or a different system from those illustrated.

Data stored in the datastore 310 may include, among other data, sensitive data such as user GPS location data. The data sampling stage may pull random subsets of the data from the datastore 310 and provide them to the geofence filter stage 410. The geofence filter stage 410 may perform geofence filtering on sample data, which may comprise table records, based a geofence filter based on and/or implemented in connection with one or more operational design domains (ODDs) of the AV fleet. In particular embodiments, as will be described in greater detail below, the geofence filter stage 410 filters out data that does not fall within a range of latitude values or longitude values that define the geofenced area. In alternative embodiments, the geofence filter stage 410 may execute a filter based on an area of interest other than a geofence defined by an ODD. For example, geofence filter stage 410 may filter out values that correspond to a latitude or longitude for a location in which it would be impossible for an AV to operate, such as a body of water. In some embodiments, geofence filter stage 410 may also filter out values that do not have a required number of digits after a decimal points as either not comprising GPS location data or not comprising data that needs to be tagged for privacy purposes. In particular embodiments, the geofence filter stage 410 may be implemented as a regex for identifying data comprising values that fall within the range of latitude or longitude values defined by the geofence area or other area of interest.

The post-processing stage 420 confirms that a given table includes values (i.e., “has a match”) for both latitude and longitude and removes any results that do not meet that criteria. The post-processing stage 420 provides the list of tables with both latitude and longitude matches as determined by the AV location detector to the tag store for sensitive data map 430, where they are tagged for privacy purposes.

### Example Onboard Computer

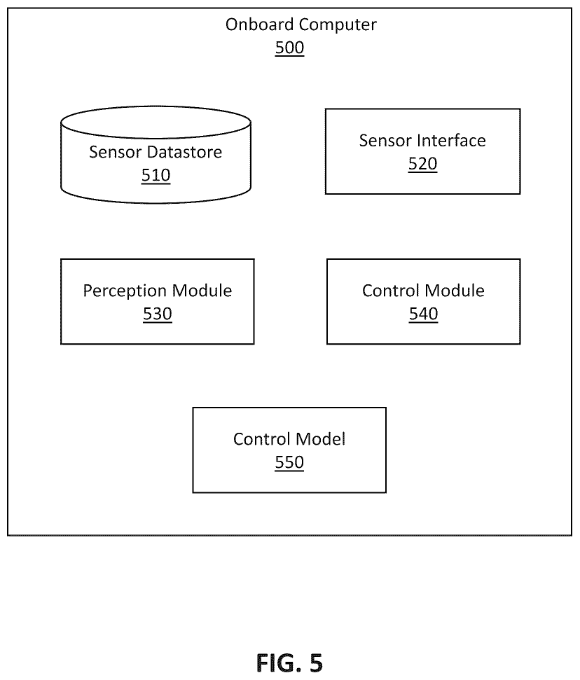

FIG. 5 is a block diagram showing the onboard computer 500, which may comprise local computing device 110, according to some embodiments of the present disclosure. The onboard computer 500 includes a sensor datastore 510, a sensor interface 520, a perception module 530, a control module 540, and a control model 550. In alternative configurations, fewer, different and/or additional components may be included in the onboard computer 500. For example, components and modules for conducting route planning, controlling movements of the AV 102, and other vehicle functions are not shown in FIG. 5. Further, functionality attributed to one component of the onboard computer 500 may be accomplished by a different component included in the onboard computer 500 or a different system from those illustrated, such as the fleet management system 300.

The sensor datastore 510 stores sensor data from the sensor suite 200, including sensor data collected by the sensor suite 200 in one or more environments around the AV 102. The sensor datastore 510 may store a detailed map of environments through which the AV 102 may travel. The sensor datastore 510 may store environmental objects captured by exterior sensors (e.g., the exterior sensor 210) of the AV 102. Some of the sensor datastore 510 may be gathered by the AV 102. For example, images obtained by exterior sensors (e.g., the exterior sensor 210) of the AV 102 may be used to learn information about the AV's environments. In some embodiments, the sensor datastore 510 may also store sensor data captured by other AVs. The sensor datastore 510 may store data in the datastore 310.

The sensor interface 520 interfaces with the sensors in the sensor suite 200. The sensor interface 520 is configured to receive data captured by sensors of the sensor suite 200, including data from exterior sensors mounted to the outside of the AV 102. The sensor interface 520 may have subcomponents for interfacing with individual sensors or groups of sensors of the sensor suite 200, such as a camera interface, a LIDAR interface, a RADAR interface, a microphone interface, etc. The sensor interface 520 may also request data from the sensor suite 200, e.g., by requesting that a sensor capture data in a particular direction or at a particular time.

The perception module 530 identifies objects captured by the sensor suite 200 of the AV 102. For example, the perception module 530 identifies objects in an environment around the AV 102 based on sensor data from one or more exterior sensors (e.g., the exterior sensor 210). In some embodiments, the perception module 530 may include one or more classifiers trained using machine learning to identify objects. In an embodiment, a multi-class classifier may be used to classify each object as one of a set of potential objects. In another embodiment, a class-specific classifier may be used to classify objects in a particular class. For instance, a pedestrian classifier recognizes pedestrians in the environment of the AV 102, a vehicle classifier recognizes vehicles in the environment of the AV 102, etc. The perception module 530 may also identify characteristics of objects based on sensor data. Example characteristics of an object include shape, size, color, material, weight, speed, orientation, and so on.

In some embodiments, the perception module 530 may use data from other sensors (e.g., the LIDAR sensor 220 or the RADAR sensor 230) to identify characteristics or status of an object. For instance, the perception module 530 may identify travel speeds of identified objects based on data from the RADAR sensor 230, e.g., speeds at which other vehicles, pedestrians, or birds are traveling. As another example, the perception module 53—may identify distances to identified object based on data (e.g., a captured point cloud) from the LIDAR sensor 220, e.g., a distance to a particular vehicle, building, or other feature identified by the perception module 530. The perception module 530 fuses data from multiple sources, such as sensors, datastores, other AVs, other systems, etc. In an example, the perception module 530 fuses data from an interior sensor with data from an exterior sensor and/or data from the datastore 310 to identify environmental features. While a single perception module 530 is shown in FIG. 5, in some embodiments, the onboard computer 500 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 540 controls operation of the AV 102 by using the control model 550. The control model 550 is an AV control model trained with privacy-protected data. In some embodiments, the privacy-protected data is a data set generated by the AV 102 or one or more other AVs. The data set may include sensor data from the sensor suite 200, objects identified by the perception module 530, or both. In other embodiments, the privacy-protected data is generated by adjusting the data set, e.g., by changing privacy information included in the data set. In some embodiments, the control model is provided by the fleet management system 300.

The control module 540 may provide input data to the control model 550, and the control model 550 outputs operation parameters of the AV 102. The input data includes sensor data from the sensor suite 200 (which may indicate a current state of the AV 102), objects identified by the perception module 530, or both. The operation parameters are parameters indicating operation to be performed by the AV 102. The operation of the AV 102 may include perception, prediction, planning, localization, navigation, other types of operation, or some combination thereof. The control module 540 may provide instructions to various components of the AV 102 based on the output of the control model 550, and these components of the AV 102 will operation in accordance with the instructions. In an example where the output of the control model 500 indicates that a change of traveling speed of the AV 102 is required given a prediction of traffic condition, the control module 540 may instruct the motor of the AV 102 to change the traveling speed of the AV 102. In another example where the output of the control model 500 indicates a need to detect characteristics of an object in the environment around the AV 102 (e.g., detect a speed limit), the control module 540 may instruct the sensor suite 200 to capture an image of the speed limit sign with sufficient resolution to read the speed limit and instruct the perception module 530 to identify the speed limit in the image.

### Example Method of Performing Large Scale Detection of AV Location Data

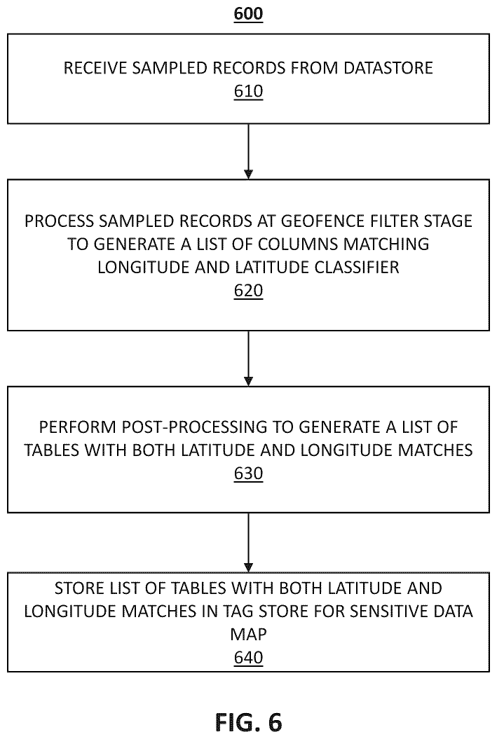

FIG. 6 is a flowchart of an example method 600 of performing large scale detection of GPS location data collected by AVs, according to some aspects of the embodiments described herein. The method 600 may be performed by the AV location detector module 320. Although the method 600 is described with reference to the flowchart illustrated in FIG. 6, many other methods of performing large scale detection of location data collected by AVs may alternatively be used. For example, the order of execution of the steps in FIG. 6 may be changed. As another example, some of the steps may be changed, eliminated, or combined.

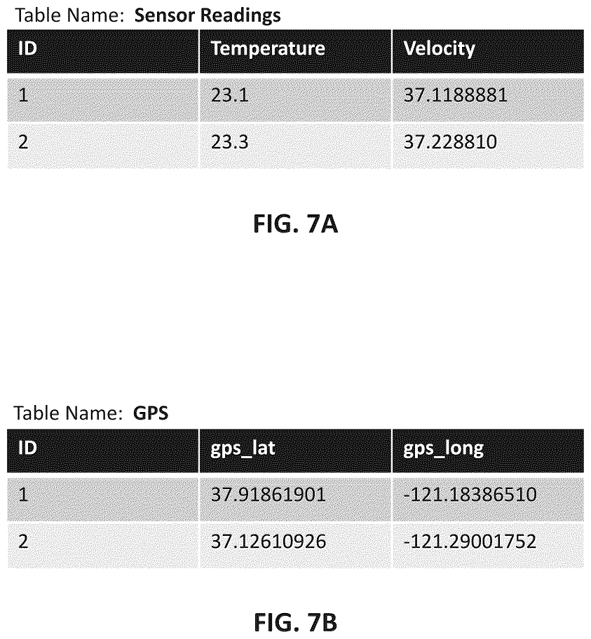

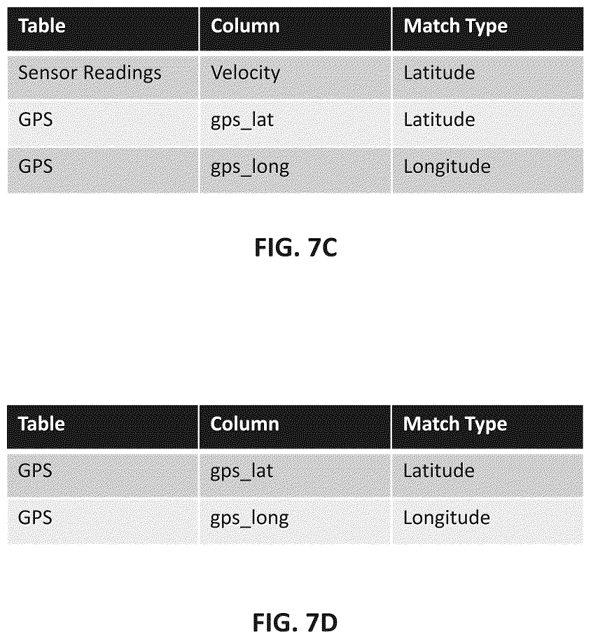

The AV location detector module 320 receives, in 810, data sampled from the datastore 310, which in particular embodiments may be a data warehouse for an AV fleet management system containing more than 14 petabytes (PB) and more than 150 million columns of data. In some embodiments, datastore 310 may be implemented using Google BigQuery and sampling of the data may be performed using a table sampling query. The sampled data provided to the AV location detector module 320 in 810 may include one or more table records, such as sensor readings records, as illustrated in FIG. 7A, and GPS records, as illustrated in FIG. 7B.

In 620, the geofence filter stage 410 of the AV location detector module 320 processes the sampled records to generate a list of columns matching a latitude and longitude classifier. In particular embodiments, 620 is performed using a regular expression (RegEx) to filter the sampled records in accordance with a geofenced location. In particular, data must fall within a designated range of latitude and longitude values as defined by the geofence in order to be qualify as GPS location data. Additionally, the regex implements a check for a minimum number of digits, as location data are not privacy relevant if truncated. Assuming the relevant geofence is the San Francisco area and the records illustrated in FIGS. 7A and 7B are input to the geofence filter stage 410, the geofence filter stage will return the data illustrated in the table shown in FIG. 7C. In particular, the geofence filter stage 410 filters out the column “temperature” (FIG. 7A), which is in the range of valid geolocation data but is not within the San Francisco geofence. On the other hand, “velocity” (FIG. 7A) is within the range of valid San Francisco latitude values and is therefore not filtered out.

In 630, the post-processing stage 420 of the AV location detector module 320 confirms that a given table has a match for both latitude and longitude and removes records for which that is not the case. Referring again to FIG. 7C, only table GPS has both a match for both latitude and longitude. In contrast, table Sensor Readings only has a match for the latitude column and is therefore filtered out. Results of this process are illustrated in FIG. 7D.

In 640, the list of tables with both latitude and longitude matches generated by the post-processing stage 420 (e.g., as illustrated as FIG. 7D) are provided to the tag store for sensitive data map 430, where the records are tagged in accordance with legal and regulatory privacy requirements. Tags may indicate retention periods (e.g., tag indicates how long data may be retained before being deleted), legal holds (e.g., tag identifies data that must be retained for a certain period of time), access control (e.g., tag identifies data that is subject to strict access controls/abuse detections), and data subject access/deletion (DSR) requests (e.g., tag identifies data that must be included when customers ask for their data as part of a DS request, for example.

In particular embodiments, the regex formulation of the search may be extended to implement multiple geofences. Precise GPS location data is of interest for privacy compliance in a wide variety of sectors in addition to AVs. Sectors in which geofence-based filtering such as described herein may apply now or in the future include mobile app users within a particular jurisdiction, interaction with point of sale (POS) devices in major cities, military operations wishing to keep precise location of deployments secret, and location-based mobile apps.

### Example Processor-Based System

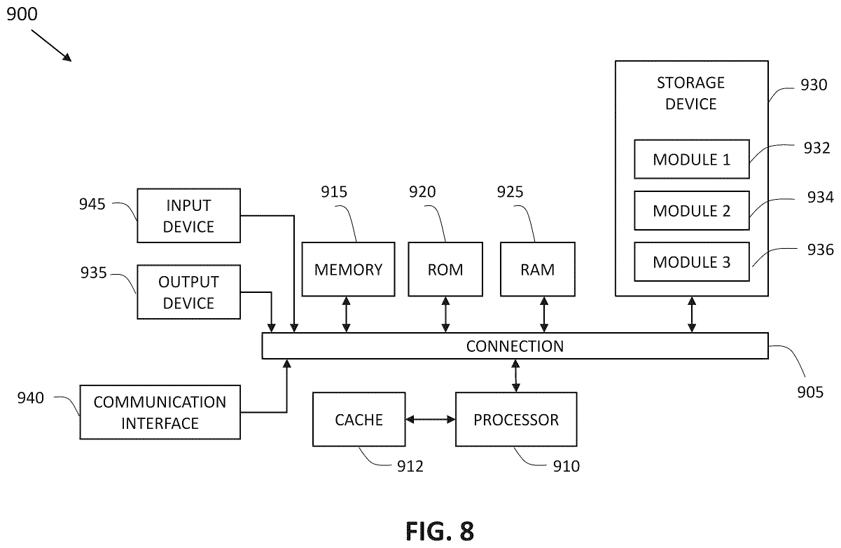

FIG. 8 illustrates an example processor-based system with which some aspects of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general purpose processor and a hardware service or software service, such as modules 932, 934, and 936 stored in storage device 930, configured to control processor 910 as well as a special purpose processor where software instructions are incorporated into the actual processor design. One or more of modules 932, 934, and 936 may include instructions for performing one or more of operations described in connection with FIGS. 3 and/or 4. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more GNSS receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc ROM (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECT EXAMPLES

Example 1 includes a method, comprising receiving a data set from a data store comprising a plurality of data in connection with an autonomous vehicle (AV) fleet, the received data set comprising a plurality of table records; filtering the received data set by comparing data values of the plurality of table records with a range of latitude values and a range of longitude values and removing from the data set table records comprising data values outside both the range of latitude values and the range of longitude values; post-processing the filtered data set to identify tables that include a first table record comprising a data value within the range of latitude values and a corresponding second table record comprising a data value within the range of longitude values; and storing information regarding the identified tables in a data map, wherein the identified tables are tagged to indicate that the identified tables include location information.

Example 2 provides the method of example 1, wherein the filtering is performed using a regular expression (regex) for comparing the data values with the range of latitude values and the range of longitude values.

Example 3 provides the method of example 1, wherein the AV fleet operates in a geofenced area.

Example 4 provides the method of example 3, wherein the range of latitude values and the range of longitude values collectively correspond to boundaries of the geofenced area.

Example 5 provides the method of example 1, wherein the AV fleet operates in a plurality of geofenced areas.

Example 6 provides the method of example 5, wherein the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.

Example 7 provides the method of example 1, wherein the filtering further comprises removing from the data set table records comprising data values truncated to less than a predetermined number of decimal places.

Example 8 provides the method of example 1, wherein the data values comprise one or more of sensor readings, temperature values, and GPS location values.

Example 9 provides the method of example 1, wherein the data store comprises a serverless cloud-based data warehouse.

Example 10 provides one or more non-transitory computer-readable media storing instructions executable to perform operations, the operations comprising receiving a data set from a data store comprising a plurality of data in connection with an autonomous vehicle (AV) fleet, the received data set comprising a plurality of table records; filtering the received data set by comparing data values of the plurality of table records with a range of latitude values and a range of longitude values and removing from the data set table records comprising data values outside both the range of latitude values and the range of longitude values; post-processing the filtered data set to identify tables that include a first table record comprising a data value within the range of latitude values and a corresponding second table record comprising a data value within the range of longitude values; and storing information regarding the identified tables in a data map, wherein the identified tables are tagged to indicate that the identified tables include location information.

Example 11 provides the one or more non-transitory computer-readable media of example 10, wherein the filtering is performed using a regular expression (regex) for comparing the data values with the range of latitude values and the range of longitude values.

Example 12 provides the one or more non-transitory computer-readable media of example 10, wherein the AV fleet operates in a geofenced area.

Example 13 provides the one or more non-transitory computer-readable media of example 12, wherein the range of latitude values and the range of longitude values collectively correspond to boundaries of the geofenced area.

Example 14 provides the one or more non-transitory computer-readable media of example 10, wherein the AV fleet operates in a plurality of geofenced areas.

Example 15 provides the one or more non-transitory computer-readable media of example 14, wherein the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.

Example 16 provides the one or more non-transitory computer-readable media of example 10, wherein the filtering further comprises removing from the data set table records comprising data values truncated to less than a predetermined number of decimal places.

Example 17 provides a computer system, comprising a computer processor for executing computer program instructions; and one or more non-transitory computer-readable media storing computer program instructions executable by the computer processor to perform operations comprising receiving a data set from a data store comprising a plurality of data in connection with an autonomous vehicle (AV) fleet, the received data set comprising a plurality of table records; filtering the received data set by comparing data values of the plurality of table records with a range of latitude values and a range of longitude values and removing from the data set table records comprising data values outside both the range of latitude values and the range of longitude values; post-processing the filtered data set to identify tables that include a first table record comprising a data value within the range of latitude values and a corresponding second table record comprising a data value within the range of longitude values; and storing information regarding the identified tables in a data map, wherein the identified tables are tagged to indicate that the identified tables include location information.

Example 18 provides the computer system of example 17, wherein the filtering is performed using a regular expression (regex) for comparing the data values with the range of latitude values and the range of longitude values.

Example 19 provides the computer system of example 17, wherein the AV fleet operates in a geofenced area and the range of latitude values and the range of longitude values collectively correspond to boundaries of the geofenced area.

Example 20 provides the computer system of example 17, wherein the AV fleet operates in a plurality of geofenced areas and the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving a data set from a data store comprising a plurality of data in connection with an autonomous vehicle (AV) fleet, the received data set comprising a plurality of table records;
filtering the received data set by comparing data values of the plurality of table records with a range of latitude values and a range of longitude values and removing from the data set table records comprising data values outside both the range of latitude values and the range of longitude values;
post-processing the filtered data set to identify tables that include a first table record comprising a data value within the range of latitude values and a corresponding second table record comprising a data value within the range of longitude values; and
storing information regarding the identified tables in a data map, wherein the identified tables are tagged to indicate that the identified tables include location information.

2. The method of claim 1, wherein the filtering is performed using a regular expression (regex) for comparing the data values with the range of latitude values and the range of longitude values.

3. The method of claim 1, wherein the AV fleet operates in a geofenced area.

4. The method of claim 3, wherein the range of latitude values and the range of longitude values collectively correspond to boundaries of the geofenced area.

5. The method of claim 1, wherein the AV fleet operates in a plurality of geofenced areas.

6. The method of claim 5, wherein the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.

7. The method of claim 1, wherein the filtering further comprises removing from the data set table records comprising data values truncated to less than a predetermined number of decimal places.

8. The method of claim 1, wherein the data values comprise one or more of sensor readings, temperature values, and GPS location values.

9. The method of claim 1, wherein the data store comprises a serverless cloud-based data warehouse.

10. One or more non-transitory computer-readable media storing instructions executable to perform operations, the operations comprising:
receiving a data set from a data store comprising a plurality of data in connection with an autonomous vehicle (AV) fleet, the received data set comprising a plurality of table records;
filtering the received data set by comparing data values of the plurality of table records with a range of latitude values and a range of longitude values and removing from the data set table records comprising data values outside both the range of latitude values and the range of longitude values;
post-processing the filtered data set to identify tables that include a first table record comprising a data value within the range of latitude values and a corresponding second table record comprising a data value within the range of longitude values; and
storing information regarding the identified tables in a data map, wherein the identified tables are tagged to indicate that the identified tables include location information.

11. The one or more non-transitory computer-readable media of claim 10, wherein the filtering is performed using a regular expression (regex) for comparing the data values with the range of latitude values and the range of longitude values.

12. The one or more non-transitory computer-readable media of claim 10, wherein the AV fleet operates in a geofenced area.

13. The one or more non-transitory computer-readable media of claim 12, wherein the range of latitude values and the range of longitude values collectively correspond to boundaries of the geofenced area.

14. The one or more non-transitory computer-readable media of claim 10, wherein the AV fleet operates in a plurality of geofenced areas.

15. The one or more non-transitory computer-readable media of claim 14, wherein the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.

16. The one or more non-transitory computer-readable media of claim 10, wherein the filtering further comprises removing from the data set table records comprising data values truncated to less than a predetermined number of decimal places.

17. A computer system, comprising:
a computer processor for executing computer program instructions; and
one or more non-transitory computer-readable media storing computer program instructions executable by the computer processor to perform operations comprising:
receiving a data set from a data store comprising a plurality of data in connection with an autonomous vehicle (AV) fleet, the received data set comprising a plurality of table records;
filtering the received data set by comparing data values of the plurality of table records with a range of latitude values and a range of longitude values and removing from the data set table records comprising data values outside both the range of latitude values and the range of longitude values;
post-processing the filtered data set to identify tables that include a first table record comprising a data value within the range of latitude values and a corresponding second table record comprising a data value within the range of longitude values; and
storing information regarding the identified tables in a data map, wherein the identified tables are tagged to indicate that the identified tables include location information.

18. The computer system of claim 17, wherein the filtering is performed using a regular expression (regex) for comparing the data values with the range of latitude values and the range of longitude values.

19. The computer system of claim 17, wherein the AV fleet operates in a geofenced area and the range of latitude values and the range of longitude values collectively correspond to boundaries of the geofenced area.

20. The computer system of claim 17, wherein the AV fleet operates in a plurality of geofenced areas and the range of latitude values comprises a plurality of ranges of latitude values and the range of longitude values comprises a plurality of ranges of longitude values and wherein the plurality of ranges of latitude values and the plurality of ranges of longitude values collectively correspond to boundaries of the pluralities of geofenced areas.
